(19) United States
(12) Patent Application Publication
(10) Pub. No.: US 2007/0239088 A1
(43) Pub. Date: Oct. 11, 2007

(54) Body vibration machine

(75) Inventor: Mu-Chuan Wu, Tainan Hsien (TW)

Correspondence Address: BACON & THOMAS, PLLC, 625 SLATERS LANE, FOURTH FLOOR, ALEXANDRIA, VA, 22314, US

(73) Assignee: Tonic Fitness Technology, Inc., Tainan Hsien (TW)

(21) Appl. No.: 11/429,197

(22) Filed: May 8, 2006

(30) Foreign Application Priority Data
Apr. 7, 2006 (TW) 0095112755

(51) Int. Cl. A61H 1/00

(52) U.S. Cl. 601/49; 601/30; 601/27

(57) ABSTRACT

A body vibration machine includes two vibrating plates respectively and independently assembled at the location on which user's feet step. The two vibrating plates are respectively supported by elastic support members, and two vibration driving device (like vibration motors) are respectively installed under the vibrating plates. The two vibrating plates can be respectively modulated in vibration frequency and controlled to start or stop operating according to user's need.

### 1. FIELD OF THE INVENTION

This invention relates to a body vibration machine, particularly to one whose vibration frequency received by a user's feet can be modulated according to practical needs and which can be controlled to start or stop operating anytime, flexible in use and able to satisfy users of different foot conditions.

### 2. DESCRIPTION OF THE PRIOR ART

A vibration-training method is one using a machine to trigger a man's muscles to vibrate for attaining the effect of stimulating a man's neuromuscular system, and the stimulating intensity is decided by the vibration frequency and the amplitude of the vibration. The vibration frequency means a cycle of the vibration in a unit time to be numerated with HZ, while the amplitude means a half of the differential value between the maximum and the minimum value in the cyclic vibration. Vibration training is helpful to promote the maximum equal-length muscular force and the maximum dynamic muscular force for those who were not trained and are aged, and it also can help maintain the density of osseous tissue of the aged. Therefore, vibration training has following advantages in physiological reaction.

1. It can effectively strengthen nervous muscles.

2. It can enhance a man's muscular force, muscular exploding force and the extent of muscle softness in a short period.

3. It has excellent effect on rehabilitation, such as abating ache in the lower half back, improvement of osteoporosis and rheumatoid arthritis as well as delay of senility.

4. It is beneficial to a man's circulatory system and able to promote the function of metabolism.

5. It has effect on bodybuilding and health protection.

A conventional body vibration machine is provided with a vibrating plate for a user's feet to step thereon and a single vibration motor for driving the vibrating stand to vibrate. However, the vibration frequency and the amplitude produced by the vibration motor are evenly distributed to two feet. Therefore, such a conventional body vibration machine is not applicable for a user whose feet have different strengths and need to receive different vibration frequencies. In addition, if only one foot needs to take vibration training, the user has to lift and suspend the other foot in the air, thus likely to cause stumbling and falling to a user (especially to one who is under rehabilitation) because of the unstable gravitational center of his body.

### SUMMARY OF THE INVENTION

The objective of the invention is to offer a body vibration machine able to be modulated in vibration frequency and controlled to start or stop operating according to a user's needs.

The body vibration machine in the present invention includes two vibrating plates respectively and dependently installed at the location on which a user's feet step. The two vibrating plates are respectively supported by elastic support members, and two vibration driving devices (like vibration motors) are respectively assembled under and vibrate the vibrating plates. The two vibration driving devices can be respectively modulated in vibration frequency and controlled to start or stop operating according to a user's needs.

### BRIEF DESCRIPTION OF DRAWINGS

This invention will be better understood by referring to the accompanying drawings, wherein:

FIG. 1 is a perspective view of a body vibration machine in the present invention;

FIG. 2 is a partial exploded perspective view of the body vibration machine in the present invention;

FIG. 3 is a partial cross-sectional view of the body vibration machine in the present invention; and

FIG. 4 is a perspective view of the body vibration machine in a using condition in the present invention.

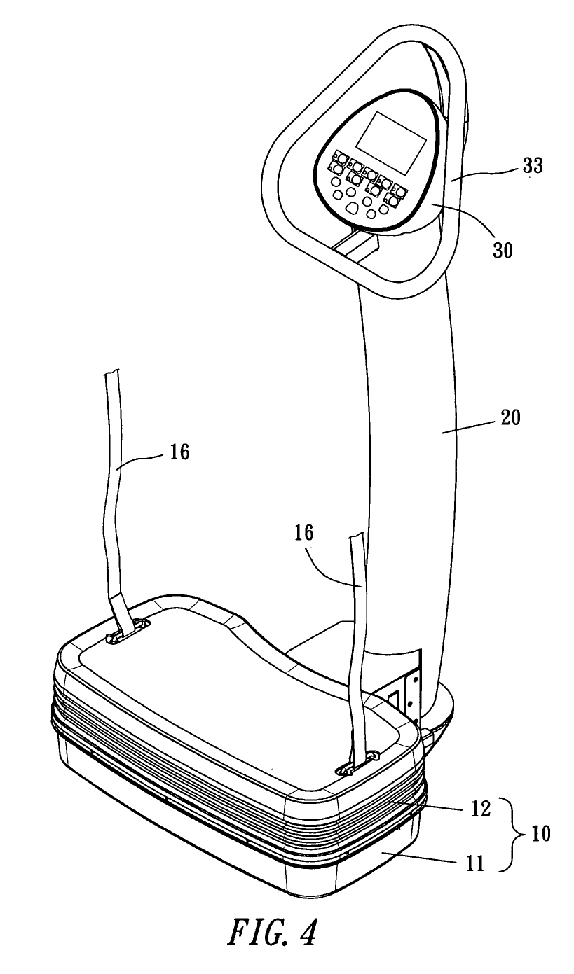

### DETAILED DESCRIPTION OF THE PREFERRED EMBODIMENT

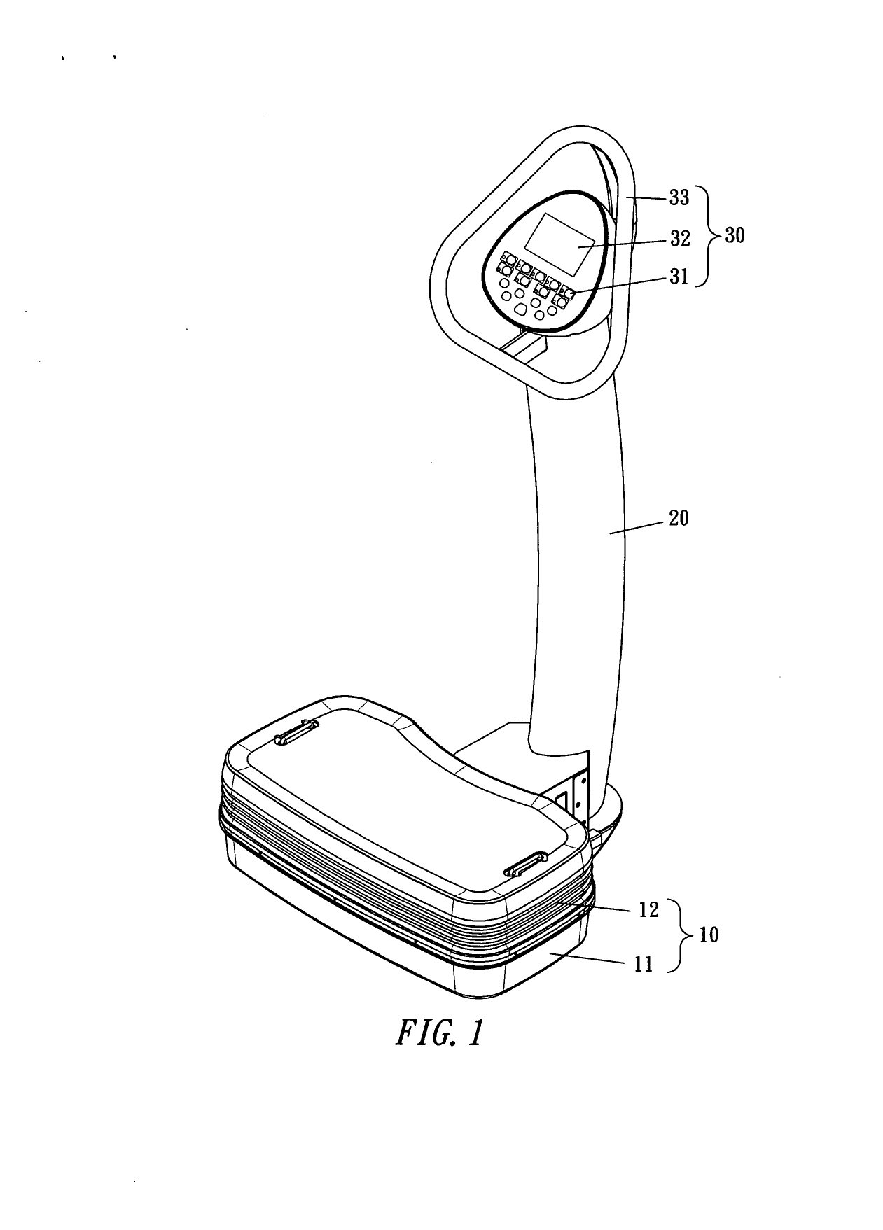

A preferred embodiment of a body vibration machine in the present invention, as shown in FIGS. 1, 2 and 3, includes a driving base 10, an upright post 20 and a control display 30 as main components combined together.

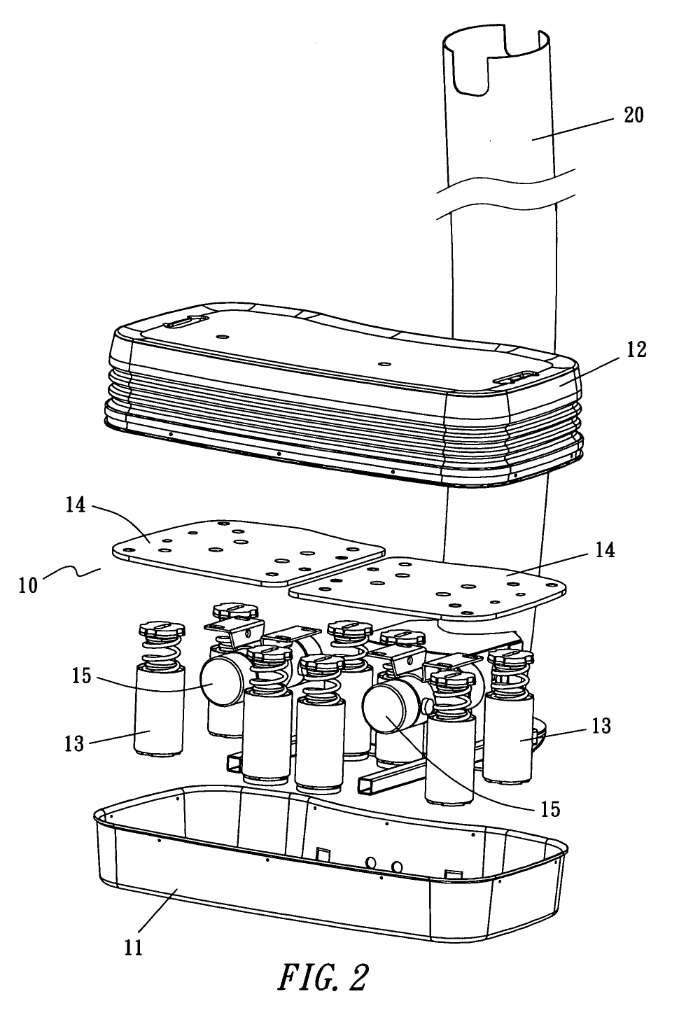

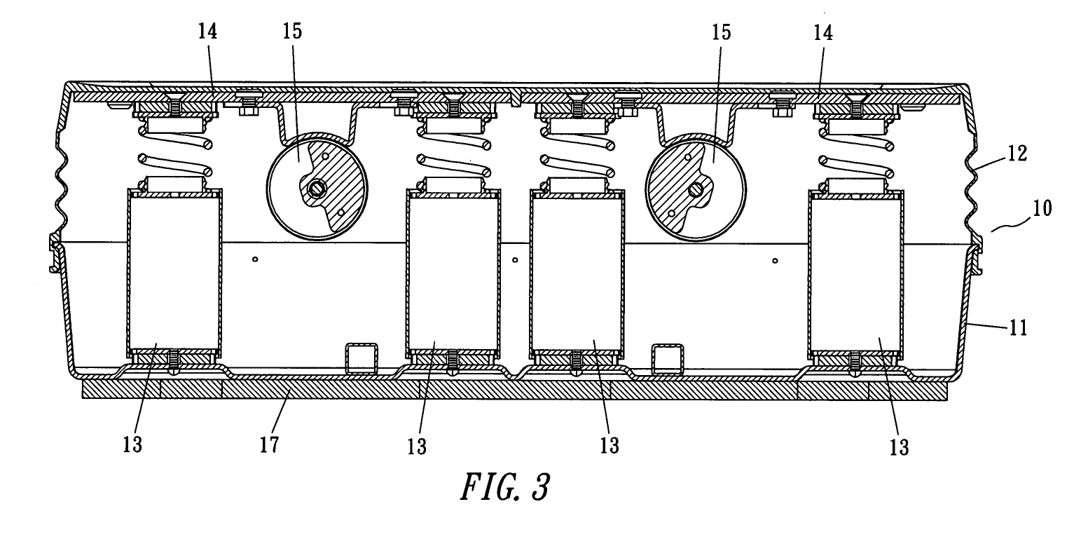

The driving base 10, as shown FIG. 2, is made by combining a lower casing 11 with an upper casing 12 together. The lower casing 11 is formed with an upside opening in the topside, and the upper casing 12 formed with an underside opening and a soft topside is fitted on the lower casing 11. A plurality of elastic support members 13 are evenly disposed in the inner space formed by the upper and the lower casing 12, 11 and have their lower ends secured on the bottom of the lower casing 11. The left and the right group of the elastic support members 13 have the upper end respectively fixed with a vibration plate 14 positioned independently and separately. Two vibration driving devices 15 (like vibration motors shown in FIG. 3) are respectively installed under the vibrating plates 14, and a soft anti-slip pad 17, such as a foamed material, is fixed at the underside of the lower casing 11 for preventing the driving base 10 from slipping.

The upright post 20 extending upward is positioned at the rear side of the driving base 10.

The control display 30 fixed at the upper end of the upright post 20 consists of controlling keys 31 and a display screen 32. A handrail frame 33 is provided around the outer side of the control display 30 for a user's hands to hold thereon so as to stabilize his body when he stands on the upper casing 12 and the vibrating stand 14.

In using, firstly, a user stands on the upper casing 12 and has his two feet respectively stepped on the left and right vibrating stand 14. Then, the two vibration drivers 15 under the two vibrating plates 14 are respectively started to drive the vibrating plates 14 to work. By so designing, the body vibration machine of this invention has the following advantages.

1. The two vibrating plates 14 are respectively driven to vibrate by one independent vibration driving device 15; therefore, the two vibrating plates 14 can be respectively modulated to vibrate with different vibration frequencies, or controlled to have only one vibrating plate 14 vibrating and the other one stopped in accordance with user's need.

2. The two vibrating plates 14 are respectively adjustable in vibration frequency for strengthening or balancing the strength of user's two feet. For instance, a user can have his comparatively weak foot stepped on one vibrating plate 14 that produces higher vibration frequency and have the other foot stepped on the other vibrating plate 14 that produces lower vibration frequency.

Moreover, aside from the handrail frame 33 to be held by user's hands, two pull ropes 16 are respectively secured at the opposite sides on the topside of the upper casing 12 of the driving base 10 for the user's left and right hand to hold for stabilizing his body.

While the preferred embodiment of the invention has been described above, it will be recognized and understood that various modifications may be made therein and the appended claims are intended to cover all such modifications that may fall within the spirit and scope of the invention.

What is claimed is:

1. A body vibrating machine comprising:
two independent standing plates under a location where user' feet step on;
plurality elastic members for supporting said two independent standing plates respectively; and
a vibration driving device respectively connected to and vibrate each said standing plate and possible to be modulated to vibrate with mutually different vibrating frequencies.

2. The body vibrating machine as claimed in claim 1, wherein a driving base consisting of an upper base and a lower base is further provided, and said standing plates, said elastic members, and said vibrating devices are limitedly installed in said driving base.

3. The body vibrating machine as claimed in claim 1, wherein said upper base has a soft upper side.

4. The body vibrating machine as claimed in claim 1, wherein said vibrating devices are a vibration motor respectively.
